(19) United States
(12) Patent Application Publication
(10) Pub. No.: US 2025/0035486 A1
(43) Pub. Date: Jan. 30, 2025

(54) MULTI-DIMENSIONAL SPECTROMETER CALIBRATION

(71) Applicant: Thermo Fisher Scientific (Bremen) GmbH, Bremen (DE)

(72) Inventors: Antonella Guzzonato, Delmenhorst (DE); Isabel Fernanda Huebener, Bremen (DE)

(21) Appl. No.: 18/716,746

(22) PCT Filed: Dec. 9, 2022
(86) PCT No.: PCT/EP2022/085105

§ 371 Date: Jun. 5, 2024

(30) Foreign Application Priority Data
Dec. 10, 2021 (EP) 21213576.8

(51) Int. Cl. G01J 3/28; G01J 3/02; G01J 3/18; G01N 21/27

(52) U.S. Cl. CPC G01J 3/2803; G01J 3/0264; G01J 3/027; G01J 3/1809; G01N 21/274; G01J 2003/2859

(57) ABSTRACT

Disclosed herein are spectrometer support systems, as well as related methods, computing devices, and computer-readable media. For example, in some embodiments, a spectrometer support apparatus may: receive, for each of a plurality of calibration samples of an analyte at different known concentrations, an array of spectrometer output intensities of the calibration sample, wherein different ones of the spectrometer output intensities in the array are associated with data representative of different deflection amounts; train a machine-learning computational model, using the plurality of known concentrations of the analyte in the calibration samples and the associated plurality of arrays of spectrometer output intensities, to output a concentration of the analyte in a target sample based on an input array of spectrometer output intensities of the target sample; and use the trained machine-learning computational model as a calibration model for the analyte for subsequent spectrometer operation.

### BACKGROUND

Many scientific instruments require calibration, the association between the output of the scientific instrument and a known state or property. Spectrometers, for example, may output an intensity that is a function of a property of a sample, and the calibration of such spectrometers may specify a relationship between the output intensity and the sample property.

### BRIEF DESCRIPTION OF THE DRAWINGS

Embodiments will be readily understood by the following detailed description in conjunction with the accompanying drawings. To facilitate this description, like reference numerals designate like structural elements.

Embodiments are illustrated by way of example, not by way of limitation, in the figures of the accompanying drawings.

FIG. 1 is a block diagram of a spectrometry system configured to perform or facilitate the support operations disclosed herein, in accordance with various embodiments.

FIG. 2 illustrates a detector array on which an image of an echelle spectrum has been formed in a spectrometry system, in accordance with various embodiments.

FIG. 3 is a block diagram of an example spectrometer support module for performing support operations, in accordance with various embodiments.

FIGS. 4-10 illustrates example arrays of spectrometer output intensities that may be used by the spectrometer support modules disclosed herein, in accordance with various embodiments.

FIG. 11 is a diagram of a machine-learning computational model that may be included in a spectrometer support module, in accordance with various embodiments.

FIG. 12 illustrates a set of training data that may be used to train a machine-learning computational model included in a spectrometer support module, in accordance with various embodiments.

FIGS. 13-17 are flow diagrams of example method of performing spectrometer support operations, in accordance with various embodiments.

FIG. 18 is an example of a graphical user interface that may be used in the performance of some or all of the support methods disclosed herein, in accordance with various embodiments.

FIG. 19 is a block diagram of an example computing device that may perform some or all of the spectrometer support methods disclosed herein, in accordance with various embodiments.

FIG. 20 is a block diagram of an example spectrometer support system in which some or all of the spectrometer support methods disclosed herein may be performed, in accordance with various embodiments.

### DETAILED DESCRIPTION

Disclosed herein are spectrometer support systems, as well as related methods, computing devices, and computer-readable media. For example, in some embodiments, a spectrometer support apparatus may: generate, for each of a plurality of calibration samples of an analyte at different known concentrations, an array of spectrometer output intensities of the calibration sample, wherein different ones of the spectrometer output intensities in the array are associated with data representative of different deflection amounts; train a machine-learning computational model, using the plurality of known concentrations of the analyte in the calibration samples and the associated plurality of arrays of spectrometer output intensities, to output a concentration of the analyte in a target sample based on an input array of spectrometer output intensities of the target sample; and use the trained machine-learning computational model as a calibration model for the analyte for subsequent spectrometer operation.

The spectrometer support embodiments disclosed herein may achieve improved performance relative to conventional approaches. In conventional spectrometry, a user is required to identify a single deflection amount (representative of a diffraction order and wavelength in optical spectrometry, or a mass-to-charge ratio in mass spectrometry) and to use that single deflection amount to determine a concentration of an analyte in a sample. For example, an optical spectrometry user may use a spectrometer to analyze an unknown sample, resulting in an output intensity signal with peaks at different diffraction orders and wavelengths, and then may be required to choose a single diffraction order and wavelength at which the output intensity has a peak for use in determining the concentration of an analyte associated with the diffraction order and wavelength. However, analytes (e.g., single elements) are typically associated with multiple peaks in an output intensity signal, and any information provided by these additional peaks is conventionally discarded. Rule-based algorithms regarding which individual peaks to utilize to determine analyte concentration often fail due to their inability to account for all analysis conditions and samples. Some attempts have been made to utilize an average or sum of output intensities at different deflection amounts (e.g., diffraction orders/wavelengths or mass-to-charge ratios) to determine the concentration of an associated analyte, but these efforts have failed to achieve a significant improvement relative to the “single” deflection amount approach.

The embodiments disclosed herein allow a spectrometer support apparatus to utilize information about much more of the output intensity signal of a spectrometer than has previously been utilized in determining analyte concentrations, and thus provide increased accuracy to spectrometer technology (e.g., improvements in the computer technology supporting such spectrometers, among other improvements). Further, by reducing the need for an expert user that can selectively identify the particular deflection amount to rely on for a particular concentration determination, the embodiments disclosed herein enable non-expert users to successfully determine analyte concentrations in samples, increasing accuracy, dynamic range, and throughput, and decreasing cost.

Various ones of the embodiments disclosed herein may improve upon conventional approaches to achieve the technical advantages of more accurate determination of analyte concentrations in samples by building calibration models that use more of the output intensity signal in concentration determinations. Such technical advantages are not achievable by routine and conventional approaches, and all users of systems including such embodiments may benefit from these advantages (e.g., by assisting the user in the performance of a technical task, such as determination of analyte concentration in a sample, by means of a guided human-machine interaction process). For example, various ones of the embodiments disclosed herein may enable the performance of a calibration-less semiquantitative analysis different from conventional approaches. The technical features of the embodiments disclosed herein are thus decidedly unconventional in the field of spectrometry, as are the combinations of the features of the embodiments disclosed herein. The computational and user interface features disclosed herein do not only involve the collection and comparison of information, but apply new analytical and technical techniques to change the operation of spectrometry support systems. The present disclosure thus introduces functionality that neither a conventional computing device, nor a human, could perform.

Accordingly, the embodiments of the present disclosure may serve any of a number of technical purposes, such as controlling analyte concentration determination in a specific technical system or process (e.g., a spectrometry system or process) and determining properties of a sample by processing data obtained from spectrometry sensors.

In some embodiments, a spectrometer support apparatus may include: first logic to generate, for each of a plurality of calibration samples of an analyte at different known concentrations, an array of spectrometer output intensities of the calibration sample, wherein different ones of the spectrometer output intensities in the array are associated with data representative of different deflection amounts; second logic to train a machine-learning computational model, using the plurality of known concentrations of the analyte in the calibration samples and the associated plurality of arrays of spectrometer output intensities, to output a concentration of the analyte in a target sample based on an input array of spectrometer output intensities of the target sample; and third logic to use the trained machine-learning computational model as a calibration model for the analyte for subsequent spectrometer operation.

In some embodiments, a spectrometer support apparatus may include: first logic to generate an array of spectrometer output intensities of a sample, wherein different ones of the spectrometer output intensities in the array are associated with data representative of different deflection amounts; second logic to provide, to a trained machine-learning computational model, the received array of spectrometer output intensities, wherein the trained machine-learning computational model is to output a concentration of an analyte in the sample; and third logic to output the concentration of analyte in the sample.

In some embodiments, a spectrometer support apparatus may include: first logic to generate an array of spectrometer output intensities of a sample, wherein different ones of the spectrometer output intensities in the array are associated with data representative of different deflection amounts; second logic to generate a concentration of an analyte in the sample based on the received array of spectrometer output intensities; and third logic to output the concentration of analyte in the sample and a feature relevance indicator associated with one or more of the spectrometer output intensities.

In some embodiments, a spectrometer output apparatus may include: first logic to generate an array of spectrometer output intensities of a sample, wherein different ones of the spectrometer output intensities in the array are associated with data representative of different deflection amounts; second logic to generate a concentration of an analyte in the sample based on the received array of spectrometer output intensities without a user having to select one or more of the data representative of deflection amounts in advance of the generation of the concentration of the analyte; and third logic to output the concentration of analyte in the sample.

In some embodiments, a spectrometer support apparatus may include: first logic to generate, for each of a plurality of calibration samples of an analyte at different known concentrations, an array of spectrometer output intensities of the calibration sample, wherein different ones of the spectrometer output intensities in the array are associated with data representative of different deflection amounts; second logic to retrain a previously trained machine-learning computational mode or generate a pre-processing method for use with the previously trained machine-learning computational model, using the plurality of known concentrations of the analyte in the calibration samples and the associated plurality of arrays of spectrometer output intensities, to output a concentration of the analyte in a target sample based on an input array of spectrometer output intensities of the target sample; and third logic to use the retrained machine-learning computational model, or perform the pre-processing method along with the previously trained machine-learning computational model, as a calibration model for the analyte for subsequent spectrometer operation.

These and other embodiments disclosed herein may solve one or more of the technical problems of conventional spectrometry identified herein, such as the technical problem of insufficient calibrations that fail to adequately identify analyte concentrations during practical operation and that require expert operators to perform, by building, using, and transferring calibration models that use more of the output intensity signal in concentration determinations than conventional approaches.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

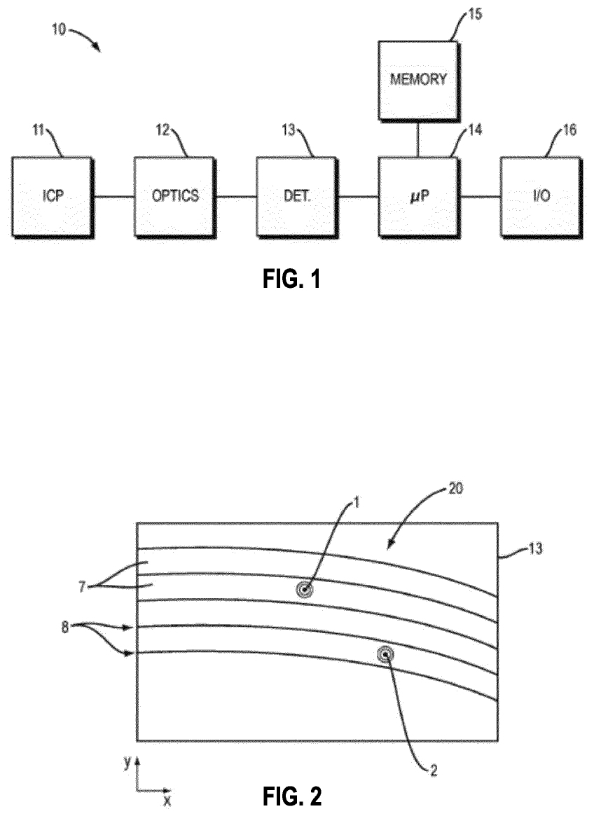

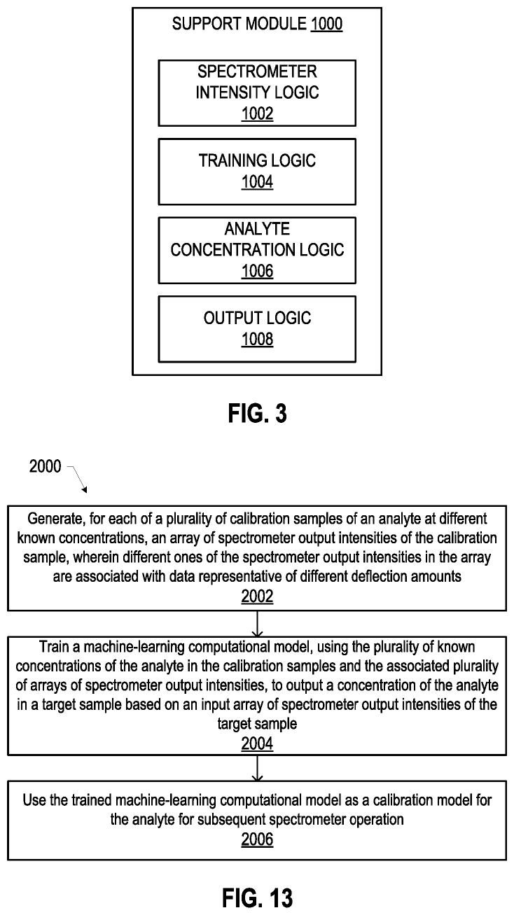

FIG. 1 is a block diagram of a spectrometry system 10 configured to perform or facilitate the support operations disclosed herein, in accordance with various embodiments. In particular, FIG. 1 illustrates an optical spectrometry system 10, but the embodiments disclosed herein may also be used with other types of spectrometry systems, such as mass spectrometry systems, The optical spectrometry system 10 of FIG. 1 may include a light source 11, an optical arrangement 12, a detector array 13, a processor 14, a memory 15 and an input/output (I/O) unit 16. The light source 11 may be a plasma source, such as an inductively coupled plasma (ICP) source. The optical arrangement 12 may comprise an echelle grating and a prism (and/or a further grating) to produce an echelle spectrum of the light produced by the light source 11. An image of the two-dimensional echelle spectrum may be formed on the detector array 13. Such an image is discussed further below with reference to FIG. 2. The detector array 13 may be a charge-coupled device (CCD) array, for example. The detector array 13 comprises an array of detector elements or pixels which produce output signals representing detected spectrum values; in some embodiments, the detector array 13 may have at least approximately 1024×1024 pixels (1 megapixel). A rectangular detector array 13 may, but need not, be square.

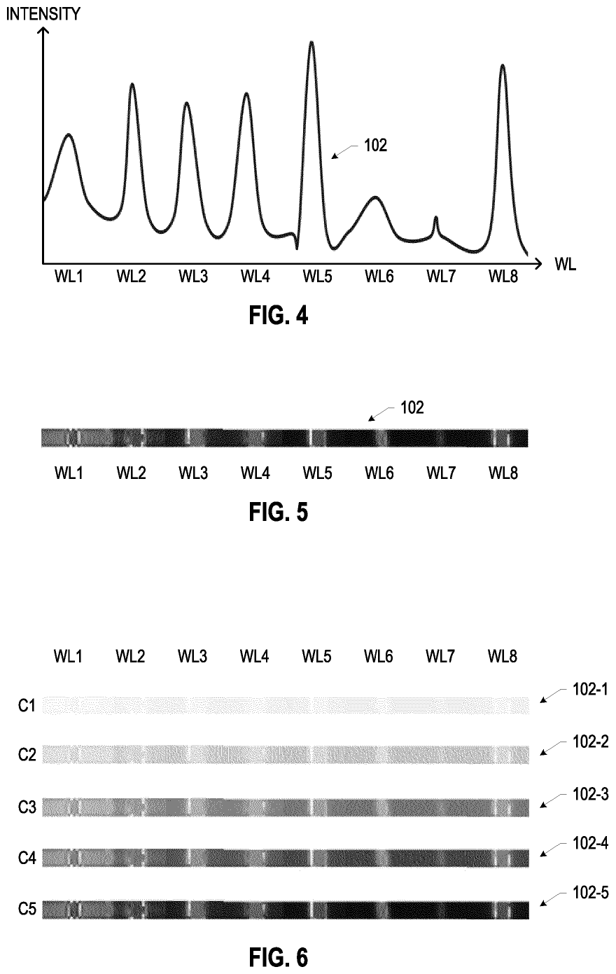

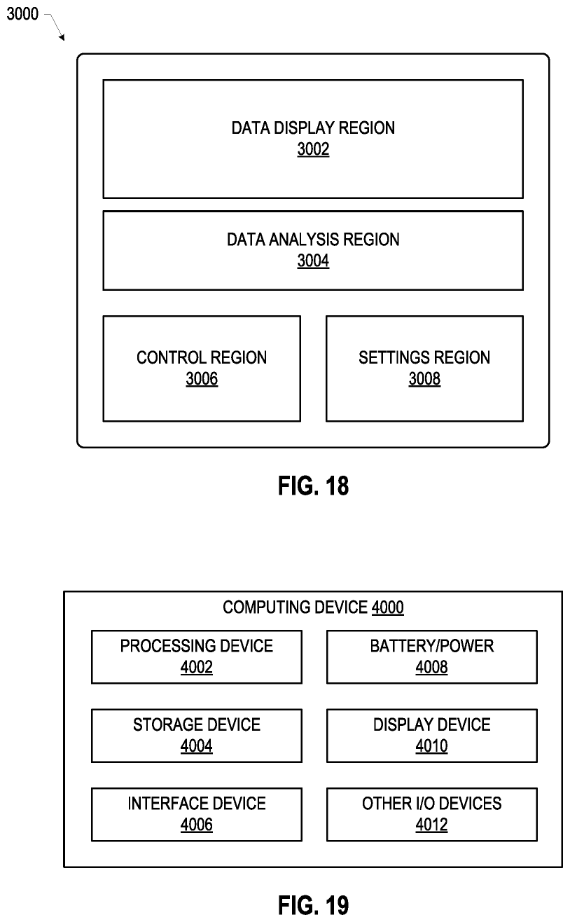

The detector array 13 may be arranged for producing spectrum values corresponding with the detected amount of light of the echelle spectrum, and for transferring the spectrum values to the processor 14. The processor 14 may include one or more commercially available processing devices (e.g., any one or more of the processing devices 4002 discussed below with reference to FIG. 19), such as one or more commercially available microprocessors. The memory 15 may include any one or more suitable storage devices (e.g., any of the storage devices 4004 discussed below with reference to FIG. 19), such as one or more suitable semiconductor memory devices, and may be used to store non-transitory computer-readable instructions that, when executed by the processor 14, cause the spectrometry system 10 to carry out one or more embodiments of the methods disclosed herein. The I/O unit 16 may include any suitable circuitry (e.g., any one or more of the interface devices 4006, display device 4010, or other I/O devices 4012 discussed below with reference to FIG. 19), and may be configured to input data or commands to the spectrometry system 10, output data from the spectrometry system 10, and/or enable communication between the spectrometry system 10 and other instruments or computing devices. Some or all of the components of the spectrometry system 10 may together implement the spectrometer support modules 1000 disclosed herein (e.g., as discussed below with reference to FIG. 3) or the spectrometer support module 1000 may be implemented by another set of hardware and/or software components and may be in communication with the spectrometry system 10 via the I/O unit 16.

FIG. 2 illustrates a detector array 13 on which an image of an echelle spectrum 20 has been formed in a spectrometry system 10, in accordance with various embodiments. The echelle spectrum 20 is shown to comprise diffraction orders 7 which individually extend approximately horizontally in FIG. 2. That is, the diffraction orders 7 extend approximately in a first direction of the detector array 13, which first direction may be referred to as the x-direction in the example of FIG. 2. Further, the diffraction orders 7 are arranged approximately in a second direction, perpendicular to the first direction, of the detector array 13, which second direction may be referred to as the y-direction. The diffraction orders 7 in an echelle spectrum 20 are typically slightly curved, so that the degree to which diffraction orders 7 are parallel or perpendicular to the first and the second direction may vary over the echelle spectrum.

In the example shown in FIG. 2, the first direction (x-direction) is parallel to the longer sides of the rectangular detector array 13, while the second direction (y-direction) is parallel to the shorter sides. It will be understood that the orientation of the detector array is chosen so as to best fit the two-dimensional spectrum and that the terms first direction and second direction can be interchanged.

The diffraction orders 7 are areas of higher light intensity and consequently higher spectrum values. The diffraction orders 7 are separated by valleys or troughs 8 of lower light intensity and hence lower spectrum values. An echelle spectrum 20 typically has one or more spectrum value peaks which are characteristic of certain substances. For instance, when using ICP as the light source 11 to produce an echelle spectrum 20, there is typically a peak representing the presence of carbon dioxide. In FIG. 2, a first peak 1 and a second peak 2 are schematically represented. In actual echelle spectra 20, more than two peaks will typically be present. Each peak is located in a diffraction order 7, and constitutes a maximum of that diffraction order 7, at least locally. It can be seen that each peak extends in both the first direction (the x-direction in FIG. 2) and the second direction (the y-direction in FIG. 2). It is noted that, in typical embodiments, peaks may have a length and a width of only a few pixels, for instance 3 to 5 pixels.

Different substances will produce peaks in different locations of the optical spectrum. As discussed above, a single peak in the optical spectrum is conventionally used to identify the analytes (e.g., single elements) in a sample under test by the spectrometry system 10. However, analytes are typically associated with multiple peaks in an output intensity signal, and any information provided by these additional peaks is conventionally discarded. As discussed further below, the embodiments disclosed herein allow a spectrometer support apparatus (that may be implemented by the spectrometry system 10 or by another system in communication with the spectrometry system 10) to utilize information about much more of the output intensity signal of a spectrometer than has previously been utilized in determining analyte concentrations, and thus provide increased accuracy to spectrometer technology (e.g., improvements in the computer technology supporting such spectrometers, among other improvements).

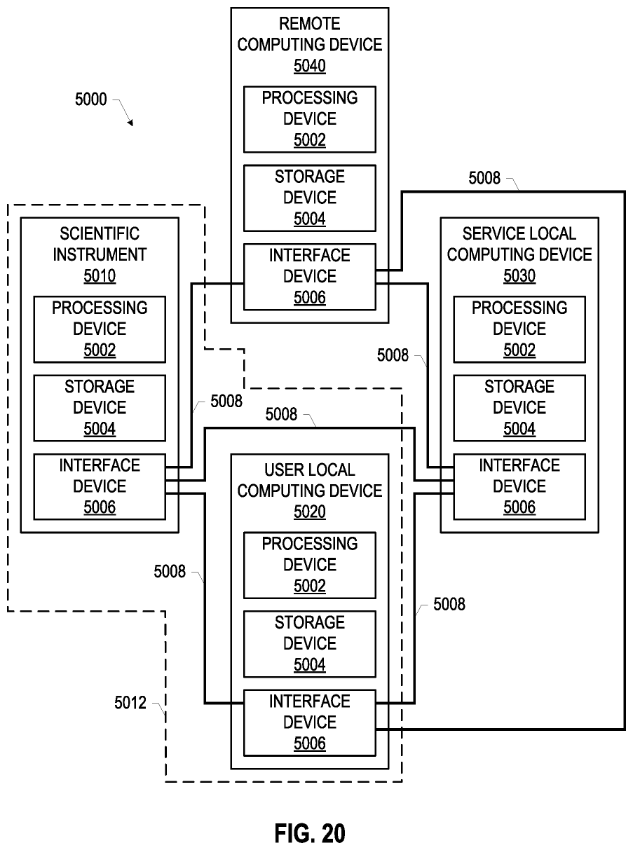

FIG. 3 is a block diagram of a spectrometer support module 1000 for performing support operations, in accordance with various embodiments. The spectrometer support module 1000 may be implemented by circuitry (e.g., including electrical and/or optical components), such as a programmed computing device. The logic of the spectrometer support module 1000 may be included in a single computing device, or may be distributed across multiple computing devices that are in communication with each other as appropriate. Examples of computing devices that may, singly or in combination, implement the spectrometer support module 1000 are discussed herein with reference to the computing device 4000 of FIG. 19, and examples of systems of interconnected computing devices, in which the spectrometer support module 1000 may be implemented across one or more of the computing devices, are discussed herein with reference to the spectrometer support system 5000 of FIG. 20. The spectrometer support module 1000 may be implemented by the spectrometry system 10 of FIG. 1 (e.g., by some or all of the processor 14, the memory 15, and the I/O unit 16 in conjunction), by another spectrometry system 10, or by a computing system in communication with a spectrometry system like the spectrometry system 10 of FIG. 1, for example.

The spectrometer support module 1000 may include spectrometer intensity logic 1002, training logic 1004, analyte concentration logic 1006, and output logic 1008. As used herein, the term “logic” may include an apparatus that is to perform a set of operations associated with the logic. For example, any of the logic elements included in the spectrometer support module 1000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The spectrometer intensity logic 1002 may generate an array of spectrometer output intensities based on data output by a spectrometer when the spectrometer is analyzing a sample. During analysis, the spectrometer may separate spectral components associated with analytes present in the sample (e.g., the elemental composition of the sample) by differently deflecting these spectral components onto a detector; the intensities measured at the detector for different deflection amounts may provide signatures of one or more analytes present in the sample. For example, as discussed above with reference to FIGS. 1 and 2, optical spectrometers may include a diffraction grating or other optical element to differently deflect radiation of different wavelengths onto one or more locations on a detector so that the intensity of incident radiation at a location on the detector represents an intensity associated with a particular wavelength of radiation. In another example, mass spectrometers may include electrical and/or magnetic fields that differently deflect ions of different mass-to-charge ratios onto locations on a detector so that the intensity of incident ions at a location on the detector represents an intensity associated with a particular mass-to-charge ratio. Thus, for any sample analyzed by the spectrometer, the spectrometer intensity logic 1002 may generate an array of spectrometer output intensities associated with the sample, wherein different ones of the spectrometer output intensities in the array or associated with data representative of different deflection amounts (e.g., diffraction orders/wavelengths or mass-to-charge ratios). As used herein, a “deflection amount” includes a dispersion amount, as appropriate in certain spectrometry systems. The embodiments disclosed herein may be used with any characteristic of the output of a spectrometer that, like deflection amount, represents multiple, characteristic, observables acting as a proxy to the identity of an analyte in a sample.

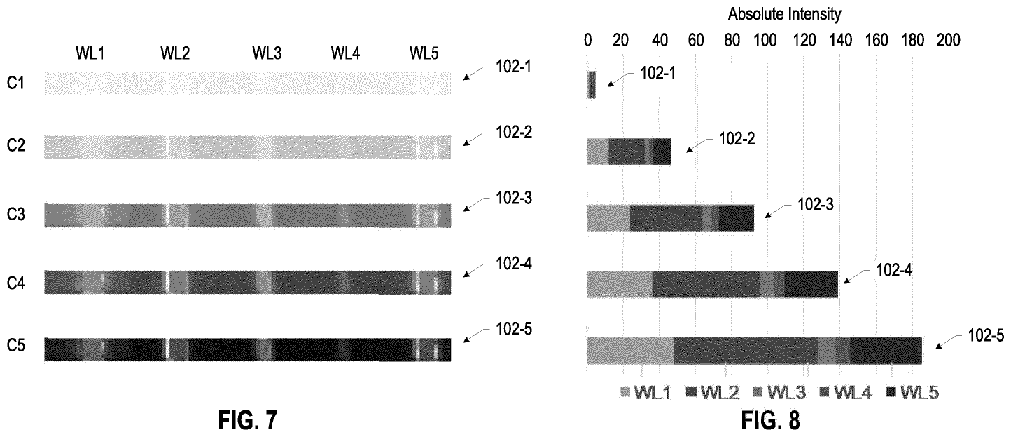

FIGS. 4-10 illustrates example arrays of spectrometer output intensities that may be used by a spectrometer support modules 1000, in accordance with various embodiments. In particular, any of the arrays of spectrometer output intensities illustrated in FIGS. 4-10 may be generated by the spectrometer intensity logic 1002 based on intensity data provided to the spectrometer intensity logic 1002 by a spectrometer. An array of spectrometer output intensities generated by the spectrometer intensity logic 1002 may be background-corrected intensities, with background correction performed in accordance with any suitable technique (e.g., any suitable background-correction technique known in the art). FIGS. 4-10, and others of the accompanying figures, may discuss spectrometer output intensities as functions of diffraction order/wavelength (as appropriate for optical spectrometry), but this is simply for ease of explanation, and the spectrometer output intensities may also be functions of other parameters representative of deflection amount (e.g., mass-to-charge ratio, as appropriate for mass spectrometry, etc.).

FIG. 4 illustrates an array of spectrometer output intensities 102 in the form of a plot of intensity as a function of wavelength. The array of spectrometer output intensities 102 illustrated in FIG. 4 may include a number of peaks at particular wavelengths (e.g., the wavelengths labeled WL1, WL2, . . . , WL8). The wavelengths at which peaks occur in an array of spectrometer output intensities 102 may be a function of the analytes (e.g., the elements) present in a sample under analysis by the spectrometer, and the magnitudes of the associated intensities at these peaks may indicate the concentration of the analytes in the sample. For a single-element sample, the wavelength locations of these peaks (referred to herein as “peak wavelengths”) may be characteristic of that element (e.g., in optical emission spectrometry, the peak wavelengths associated with aluminum may include 185.580 nanometers, 220.462 nanometers, etc.). FIG. 5 illustrates the same array of spectrometer output intensities 102 that is illustrated in FIG. 4, but in a “heat map” format in which the peaks in the array of spectrometer output intensities 102 of FIG. 4 are represented as having “lighter” grayscale values at locations associated with the wavelengths WL1, WL2, . . . ,WL8, as shown.

The spectrometer intensity logic 1002 may generate arrays of spectrometer output intensities 102 for each of multiple different samples. In particular, during calibration, the spectrometer intensity logic 1002 may generate an array of spectrometer output intensities 102 for each of multiple calibration samples, with different calibration samples having different known concentrations of an analyte of interest (e.g., an element of interest). For example, during calibration, a spectrometer may be provided with different single-element solution calibration samples having different known concentrations of molybdenum or another element of interest, and the spectrometer intensity logic 1002 may generate a different array of spectrometer output intensities 102 for each of these calibration samples. FIG. 6 illustrates a collection of five such arrays of spectrometer output intensities 102 (labeled 102-1, 102-2, . . . , 102-5) associated with five different concentrations (labeled C1, C2, . . . , C5) of an analyte of interest in corresponding calibration samples. In the particular example of FIG. 6, the concentrations of the analyte of interest may increase from C1 to C5; note that, as the concentration of the analyte of interest increases, the magnitudes of the intensities in the corresponding array of spectrometer output intensities 102 increases.

As illustrated in FIGS. 4 and 5, an array of spectrometer output intensities 102 may be represented in any of a number of ways. For example, FIG. 7 illustrates a collection of five arrays of spectrometer output intensities 102 (labeled 102-1, 102-2, . . . , 102-5) associated with five different concentrations (labeled C1, C2, . . . , C5) of an analyte of interest in corresponding calibration samples, including five wavelengths (labeled W1, W2, . . . , W5) at which intensity peaks occur. FIG. 8 illustrates the same collection of five arrays of spectrometer output intensities 102 (labeled 102-1, 102-2, . . . , 102-5) associated with five different concentrations (labeled C1, C2, . . . , C5) of an analyte of interest in corresponding calibration samples, but in which only the peak magnitudes are of interest and are represented as an aggregation of intensity magnitude for the peaks at each of the five wavelengths (labeled W1, W2, . . . ,W5). For example, the array of spectrometer output intensities 102-5 of FIG. 8 shows a magnitude of approximately 50 units for the peak associated with wavelength WL1, a magnitude of approximately 80 units for the peak associated with wavelength WL2, etc. FIG. 8 thus illustrates one way in which an array of spectrometer output intensities 102 may be specified (i.e., by peak magnitude for each of the associated peak wavelengths).

FIGS. 9-10 illustrate another manner in which an array of spectrometer output intensities 102 may be represented. FIG. 9 is a reproduction of FIG. 7 (for clarity of illustration), including the collection of five arrays of spectrometer output intensities 102 (labeled 102-1, 102-2, . . . , 102-5) associated with five different concentrations (labeled C1, C2, . . . , C5) of an analyte of interest in corresponding calibration samples, including five wavelengths (labeled W1, W2, . . . ,W5) at which intensity peaks occur. FIG. 10 illustrates the same collection of five arrays of spectrometer output intensities 102 (labeled 102-1, 102-2, . . . , 102-5) associated with five different concentrations (labeled C1, C2, . . . , C5) of an analyte of interest in corresponding calibration samples, but in which only the relative peak magnitudes are of interest and are represented as an aggregation of relative intensity magnitude for the peaks at each of the five wavelengths (labeled W1, W2, . . . ,W5). For example, the array of spectrometer output intensities 102-5 of FIG. 10 shows that approximately 25% of the total aggregated intensity magnitude of the peaks associated with wavelengths WL1, WL2, . . . , WL5 is provided by the intensity magnitude of the peak associated with WL1, approximately 72% of the total aggregated intensity magnitude of the peaks associated with wavelengths WL1, WL2, . . . , WL5 is provided by the intensity magnitude of the peak associated with wavelength WL2, etc. FIG. 10 thus illustrates another way in which an array of spectrometer output intensities 102 may be specified (i.e., by relative peak magnitude for each of the associated peak wavelengths).

The training logic 1004 may use the arrays of spectrometer output intensities 102 of the calibration samples, along with the known concentrations of the analyte of interest in the calibration samples, to train a machine-learning computational model to output a concentration of the analyte of interest in a target sample based on an input array of spectrometer output intensities 102 of the target sample. In particular, the training logic 1004 may adjust the parameters of an untrained or previously trained machine-learning computational model, in accordance with known training techniques, such that when an array of spectrometer output intensities 102 associated with a calibration sample of a known concentration is input to the machine-learning computational model, the output of the machine-learning computational model is equal or close to the value of the known concentration. Thus, such a trained machine-learning computational model may be used as a calibration model for the analyte of interest for subsequent spectrometer operation, relating spectrometer intensity output to analyte concentration.

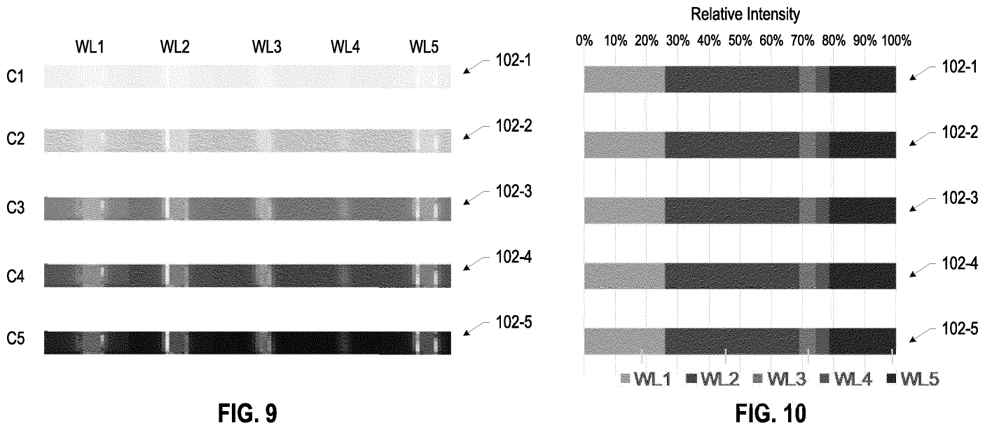

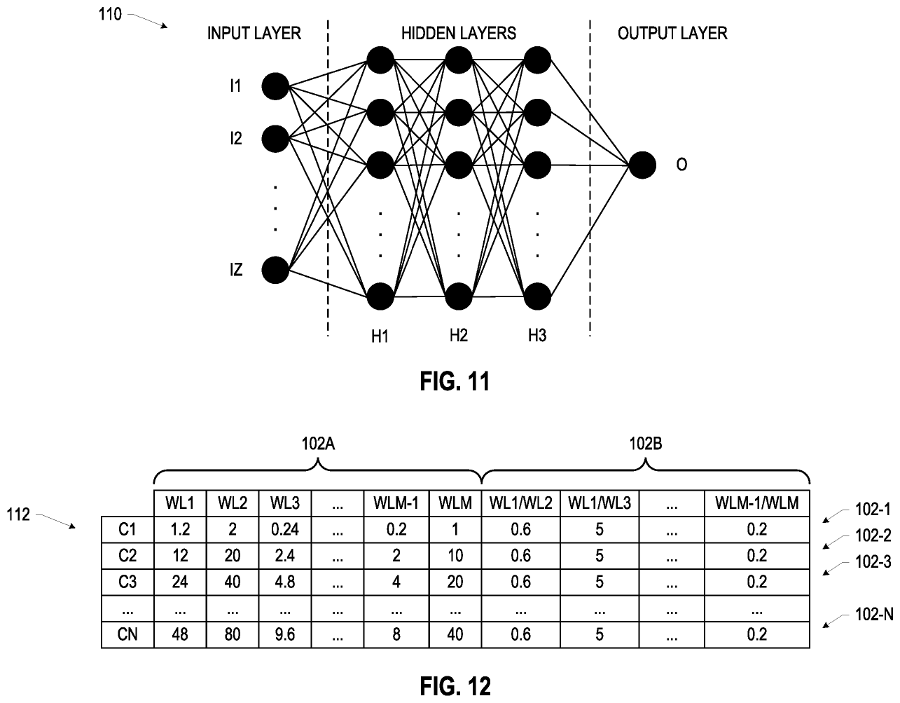

FIG. 11 is a diagram of a machine-learning computational model 110 that may be trained by the training logic 1004 using the calibration data. The number of nodes in the input layer of the machine-learning computational model 110 may be equal to the dimension of the tensor provided to the machine-learning computational model 110; a number of example tensors that may be provided to the machine-learning computational model 110 are discussed below with reference to FIG. 12. The number of hidden layers in the machine-learning computational model 110, and the number of nodes in each hidden layer, and the connectivity among the layers, may take any suitable values. For example, in some embodiments, the machine-learning computational model 110 may include eight hidden layers, between 12 and 128 nodes in each hidden layer, and full (also referred to as “dense”) connectivity between the layers. In some particular embodiments, the number of nodes in a particular layer increases for the first layers (e.g., increases between 12 and 128 in the first six layers) and decreases for the last layers (e.g., decreases from 128 down to one for the output layer). The activation functions used between layers, the error function used to train the machine-learning computational model 110, and the training technique itself may be selected as suitable. For example, in some embodiments, the activation functions used between layers may be rectified linear (ReLu), the error function used to train the machine-learning computational model may be mean standard error (MSE), and the training technique used to train the machine-learning computational model 110 may be gradient-based. In some embodiments, the number of output nodes in the machine-learning computational model 110 may be one (corresponding to the concentration of the analyte of interest in the target sample, as discussed above. As known in the art, training data (i.e., the arrays of spectrometer output intensities 102 of the calibration samples, along with the known concentrations of the analyte of interest in the calibration samples) may be normalized, encoded/decoded, or otherwise processed as part of training and using the machine-learning computational model 110.

As noted above, the array of spectrometer output intensities 102 input to the machine-learning computational model 110 may take any of a number of forms. For example, FIG. 12 illustrates a set of training data 112 that may be generated by the spectrometer intensity logic 1002 and may be used by the training logic 1004 to train a machine-learning computational model 110, in accordance with various embodiments. The training data 112 may include a set of arrays of spectrometer output intensities 102 (labeled 102-1, 102-2, . . . , 102-N) and their associated concentrations labeled (C1, C2, . . . , CN). An individual array of spectrometer output intensities 102 may include a first subarray 102A that includes the magnitudes of the spectrometer output intensity at each of multiple peak wavelengths (labeled WL1, WL2, . . . , WLM) associated with the analyte of interest. In some embodiments, an individual array of spectrometer output intensities 102 may also include a second subarray 102B that includes the pairwise ratios of the magnitudes of the spectrometer output intensities at different peak wavelengths (e.g., the magnitude of the intensity associated with the peak wavelength WL1 divided by the magnitude of the intensity associated with the magnitude of the intensity associated with the peak wavelength WL2, labeled as WL1/WL2, etc.) For analytes in which the relative magnitudes associated with the peak wavelengths is consistent across different concentrations of an analyte of interest (as discussed above with reference to FIG. 10), including the ratios of different ones of the peak magnitudes in the tensor input to the machine-learning computational model 110 may aid the training of the machine-learning computational model 110 in more quickly recognizing the relevance of this information in determining the concentration of the analyte of interest in a sample. In some embodiments, the array of spectrometer output intensities 102 input to a machine-learning computational model 110 may only include the first subarray 102A, and may not include the second subarray 102B, or may include other representations of the array of spectrometer output intensities 102 (e.g., other functions or combinations of the magnitudes of the intensities at different peak wavelengths and/or intensity data at non-peak wavelengths). Further, the array of spectrometer output intensities 102 input to a machine-learning computational model 110 may not represent the magnitudes of the intensities at all peak wavelengths associated with an analyte of interest, but may represent the magnitudes of the intensities at a subset of peak wavelengths.

The training logic 1004 may train a different machine-learning computational model 110 for each different analyte of interest. For example, the training logic 1004 may use calibration data for each of multiple single-element samples to generate multiple associated machine-learning computational models 110, each associated with a different particular element. In other embodiments, a single machine-learning computational model 110 may be trained to generate the concentrations of multiple analytes of interest based on an array of spectrometer output intensities 102; in such embodiments, the number of output nodes of the machine-learning computational model 110 may be equal to the number of analytes whose concentration may be determined by the machine-learning computational model 110. Although various ones of the embodiments disclosed herein may be described with reference to a single analyte of interest associated with a single machine-learning computational model 110, this is simply for ease of illustration, and any of the techniques disclosed herein may use a single machine-learning computational model 110 to generate concentrations of multiple analytes of interest.

In some embodiments, the training logic 1004 may use training data that includes one or more saturated spectrometer output intensities to train the machine-learning computational model 110. Conventionally, a peak wavelength at which the spectrometer output intensity is saturated (i.e., reaches the upper limit of the intensity that can be resolved by the detector) is discarded during subsequent analysis. However, the techniques disclosed herein allow the intensity data associated with multiple peak wavelengths to be used together to determine an analyte concentration, and thus having the training logic 1004 use some training data that includes saturated intensities may help the machine-learning computational model 110 contextualize such data and more heavily rely on non-saturated intensities, when input, to make a proper concentration determination. Because the analyte concentration determination techniques disclosed herein are able to properly determine concentration even when saturation occurs (and also when low-sensitivity peaks are absent from intensity signals representative of low-concentration samples), the spectrometer support modules 1000 disclosed herein can significantly increase the dynamic range of the spectrometer relative to conventional approaches. In some embodiments, the training data may be pre-processed by the training logic 1004, before it is used to train the machine-learning computational model, to remove some or all of the saturated or otherwise abnormal spectrometer output intensities. For example, the training logic 1004 may pre-process the training data by performing an initial linearity check, during which the magnitude of peaks associated with different samples may be compared to determine whether the ratio of the magnitudes of the peaks is approximately equal to the ratio of the concentrations of an associated analyte in the sample, as would be expected based on physical principles. If one or more peaks fails this linearity check (e.g., due to saturation, insufficient intensity, or interference), the peaks may be discarded from the set of data used to train the machine-learning computational model.

In some embodiments, the training logic 1004 may retrain a machine-learning computational model 110. For example, as calibration of a spectrometer is re-performed for a particular analyte, the training logic 1004 may use the new calibration data to retrain a previously trained machine-learning computational model 110 (e.g., to correct for drift or other changes since the previous calibration and/or to improve the quality of the calibration by using more data). In another example, a machine-learning computational model 110 that has been trained to output concentrations of one or more particular analytes on a particular spectrometer may be retrained by the training logic 1004 to output concentrations of the analytes on a different spectrometer. When retraining a machine-learning computational model 110 for a different spectrometer, the training logic 1004 may use a transfer learning technique in which only the last fully connected layer of the previously trained machine-learning computational model 110 (or another subset of the parameters of the previously trained machine-learning computational model 110) is retrained, while the other parameters are maintained as fixed. Utilizing such a technique may reduce the training burden associated with building machine-learning computational models 110 for other spectrometers while still achieving customization of the machine-learning computational model 110 for the particular spectrometer at hand. A transfer learning approach may also take into account the operating conditions (e.g., acquisition settings) of different instruments; these operating conditions may be used in combination with the training data discussed above (which may cover all elements of interest over a concentration span that covers the instrument's dynamic range) to construct a full model of a first instrument's behavior, and then a model may be readily deployed on a second instrument by performing a set of linear translations of the full model from the first instrument.

In some embodiments, the training logic 1004 may perform a transfer learning technique that does not require the re-training of the machine-learning computational model 110. The training logic 1004 may be configured to perform such a technique, for example, when the internal or operating conditions of the instrument have changed (which may lead to changes in the measured values of the intensities for the same concentration of a given analyte), or when deploying the machine-learning computational model 110 to a second instrument with different operating conditions. In both such cases, the training logic 1004 may renormalize the intensities before the machine-learning computational model 110 is used to output concentration data. To renormalize the intensities, the training logic 1004 may utilize a new array of intensities, representing at least one known concentration of a selected analyte, measured by the instrument. These concentrations need not be predefined and can be chosen, for example, by a user of the instrument or a service technician. In some embodiments, the concentrations may be selected so that they fall within a linear regime of the calibration curve for the selected analyte, while in other embodiments, the concentrations need not fall within such a linear regime (e.g., when the linear regimes change as a machine-learning computational model 110 is retrained with more data). The training logic 1004 may generate a set of normalization parameters by using the existing trained machine-learning computational model 110 to generate a function of the form:
I[I1, I2, I3, . . . , In]=f(concentration),
   which returns an array of intensities (I1, 12, 13, . . . , In), one for each observed spectral emission of a particular element, that are associated with a given concentration value in the same normalized intensity-concentration space that was used to train the machine-learning computational model 110. This function may take any of a number of forms; for example, the function may be represented as a look-up table containing tuples values of (intensity, concentration) evaluated over a concentration span (which may cover the instrument's full dynamic range), or as a machine-learning based function which is trained to map concentration values back to an array of intensities, among other forms. Using this function, the training logic 1004 may transform a measured array of intensities into the normalized intensity-concentration space of the machine-learning computational model 110. The analyte concentration logic 1004 may then use the transformed array of intensities with the existing machine-learning computational model 110 to predict the concentration of a given analyte in a sample.

The analyte concentration logic 1006 may use the trained machine-learning computational model 110 as a calibration model during subsequent spectrometer operation. In particular, when the spectrometer is used to analyze a sample whose concentration of the analyte is unknown, the spectrometer intensity logic 1002 may generate an array of spectrometer output intensities 102 associated with the sample, and may provide that array of spectrometer output intensities 102 to the trained machine-learning computational model 110, with the trained machine-learning computational model 110 outputting the concentration of the analyte in the sample. Thus, in contrast to conventional approaches, the spectrometer support module 1000 may generate an analyte concentration without a user having to select a diffraction order/wavelength, mass-to-charge ratio, or other particular data representative of a deflection amount, in advance of the generation of the concentration of the analyte, reducing the burden on the user and making successful operation of a spectrometer achievable by non-expert users.

In some embodiments, the analyte concentration logic 1006 may also generate one or more feature relevance indicator associated with an analyte concentration output by the machine-learning computational model. The feature relevance indicator may indicate which of the elements in the array of spectrometer output intensities 102 were more important to the determination of the analyte concentration than others of the spectrometer output intensities. In some embodiments, the feature relevance indicator may include which of the peak wavelengths (and their associated intensity magnitudes) was most predictive of the analyte concentration (e.g., when the array of spectrometer output intensities 102 includes the first subarray 102A of FIG. 12) and/or which combination of the peak wavelengths (and their associated intensity magnitudes) was most predictive of the analyte concentration (e.g., when the array of spectrometer output intensities 102 includes the second subarray 102B of FIG. 12 or other combinations of intensity data). For example, the analyte concentration logic 1006 may generate a list of the most relevant diffraction orders, peak wavelengths, or combinations of peak wavelengths for a particulate analyte concentration determination. The analyte concentration logic 1006 may implement any feature relevance scoring methodology known in the art, such as linear regression feature relevance, logistic regression feature relevance, or decision tree feature relevance.

In some embodiments, the analyte concentration logic 1006 may perform further processing on the output of the trained machine-learning computational model to identify a concentration of an analyte in a sample. For example, in some embodiments, the analyte concentration logic 1006 may utilize the feature relevance indicators to identify which peak wavelengths were most important to the output of the machine-learning computational model, and may use the intensity magnitudes of these peak wavelengths to determine the analyte concentration. In some particular embodiments, the analyte concentration logic 1006 may round the analyte concentrations indicated by the intensity magnitudes of these “most important” peak wavelengths and may use the mode of the rounded intensity magnitudes to determine the analyte concentration. In some other particular embodiments, the analyte concentration logic 1006 may compute the weighted average of the analyte concentrations indicated by the intensity magnitudes of the “most important” peak wavelengths, with weights assigned to each peak wavelength in accordance with the feature relevance indicator (representative of, e.g., the relative influence of the output intensity associated with different ones of the peak wavelengths). In other particular embodiments, the analyte concentration logic 1006 may round the analyte concentrations indicated by the intensity magnitudes of all of the peak wavelengths, sort the analyte concentrations by decreasing frequency, and compute a weighted average of a set of the analyte concentrations that appear with the greatest frequency.

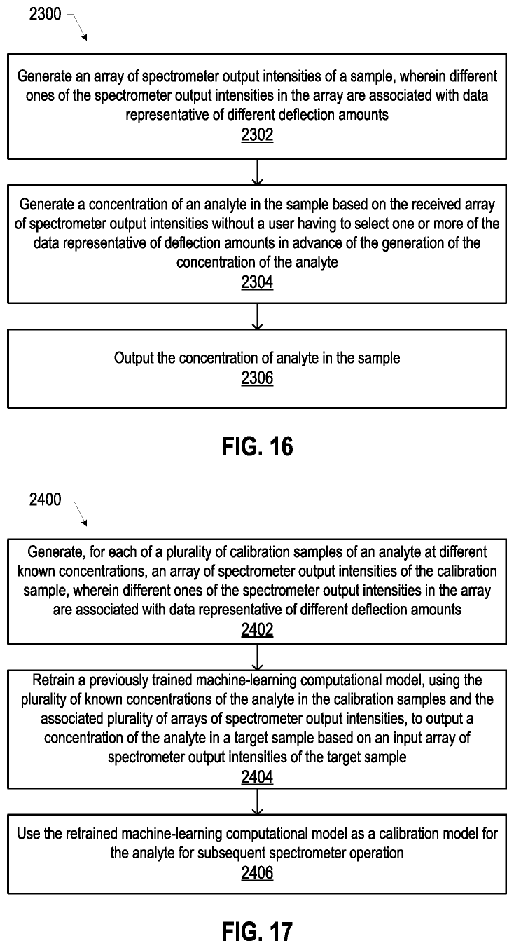

The output logic 1008 may output the concentration of analyte in a sample as determined by the analyte concentration logic 1006 (using the trained machine-learning computational model 110). In some embodiments, the output logic 1008 may also output one or more feature relevance indicator generated by the analyte concentration logic 1006 (e.g., so that a user can validate which peak wavelengths were selected as most important to an analyte concentration determination). In some embodiments, the output logic 1008 may output the analyte concentration and/or feature relevance indicators to a display device (e.g., via a graphical user interface (GUI) like the GUI 3000 of FIG. 18). In some embodiments, the output logic 1008 may output the analyte concentration and/or feature relevance indicators to a storage device (e.g., the storage device 4004 of the computing device 4000 of FIG. 19). In some embodiments, the output logic 1008 may output the analyte concentration and/or feature relevance indicators to an interface device (e.g., the interface device 4006 of the computing device 4000 of FIG. 19) for transmission to a local or remote computing device.

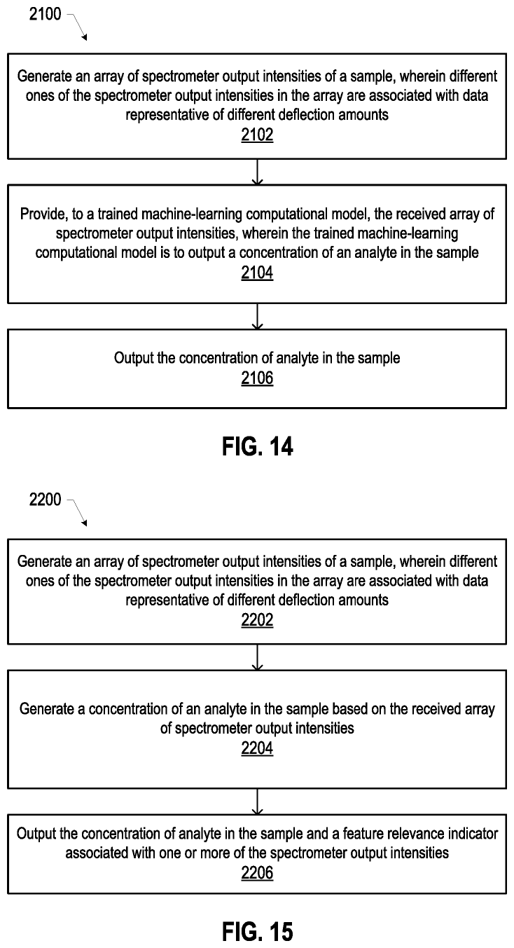

FIGS. 13-17 are flow diagrams of methods of performing spectrometer support operations, in accordance with various embodiments. Although the operations of the methods of FIGS. 13-17 may be illustrated with reference to particular embodiments disclosed herein (e.g., the spectrometer support modules 1000 discussed herein with reference to FIG. 3, the GUI 3000 discussed herein with reference to FIG. 18, the computing devices 4000 discussed herein with reference to FIG. 19, and/or the spectrometer support system 5000 discussed herein with reference to FIG. 20), the methods of FIGS. 13-17 may be used in any suitable setting to perform any suitable support operations. Operations are illustrated once each and in a particular order in FIGS. 13-17, but the operations may be reordered and/or repeated as desired and appropriate (e.g., different operations performed may be performed in parallel, as suitable).

Turning to the method 2000 of FIG. 13, at 2002, an array of spectrometer output intensities of the calibration sample may be generated for each of a plurality of calibration samples of an analyte at different known concentrations. Different ones of the spectrometer output intensities in the array may be associated with data representative of different deflection amounts. For example, the spectrometer intensity logic 1002 of a spectrometer support module 1000 may perform the operations of 2002.

At 2004, a machine-learning computational model may be trained, using the plurality of known concentrations of the analyte in the calibration samples and the associated plurality of arrays of spectrometer output intensities, to output a concentration of the analyte in a target sample based on an input array of spectrometer output intensities of the target sample. For example, the training logic 1004 of a spectrometer support module 1000 may perform the operations of 2004.

At 2006, the trained machine-learning computational model may be used as a calibration model for the analyte for subsequent spectrometer operation. For example, the analyte concentration logic 1006 of a spectrometer support module 1000 may perform the operations of 2006.

Turning to the method 2100 of FIG. 14, at 2102, an array of spectrometer output intensities of a sample may be generated. Different ones of the spectrometer output intensities in the array may be associated with data representative of different deflection amounts. For example, the spectrometer intensity logic 1002 of a spectrometer support module 1000 may perform the operations of 2102.

At 2104, the received array of spectrometer output intensities may be provided to a trained machine-learning computational model. The trained machine-learning computational model is to output a concentration of an analyte in the sample. For example, the analyte concentration logic 1006 of a spectrometer support module 1000 may perform the operations of 2104.

At 2106, the concentration of analyte in the sample may be output. For example, the output logic 1008 of a spectrometer support module 1000 may perform the operations of 2106.

Turning to the method 2200 of FIG. 15, at 2202, an array of spectrometer output intensities of a sample may be generated. Different ones of the spectrometer output intensities in the array may be associated with data representative of different deflection amounts. For example, the spectrometer intensity logic 1002 of a spectrometer support module 1000 may perform the operations of 2202.

At 2204, a concentration of an analyte in the sample may be generated based on the received array of spectrometer output intensities. For example, the analyte concentration logic 1006 of a spectrometer support module 1000 may perform the operations of 2204.

At 2206, the concentration of analyte in the sample, and a feature relevance indicator associated with one or more of the spectrometer output intensities, may be output. For example, the output logic 1008, of a spectrometer support module 1000 may perform the operations of 2206.

Turning to the method 2300 of FIG. 16, at 2302, an array of spectrometer output intensities of a sample may be generated. Different ones of the spectrometer output intensities in the array may be associated with data representative of different deflection amounts. For example, the spectrometer intensity logic 1002 of a spectrometer support module 1000 may perform the operations of 2302.

At 2304, a concentration of an analyte in the sample may be generated based on the received array of spectrometer output intensities without a user having to select one or more of the data representative of deflection amounts in advance of the generation of the concentration of the analyte. For example, the analyte concentration logic 1006 of a spectrometer support module 1000 may perform the operations of 2304.

At 2306, the concentration of analyte in the sample may be output. For example, the output logic 1008, of a spectrometer support module 1000 may perform the operations of 2306.

Turning to the method 2400 of FIG. 17, at 2402, an array of spectrometer output intensities of a calibration sample may be generated for each of a plurality of calibration samples of an analyte at different known concentrations. Different ones of the spectrometer output intensities in the array may be associated with data representative of different deflection amounts. For example, the spectrometer intensity logic 1002 of a spectrometer support module 1000 may perform the operations of 2402.

At 2404, a previously trained machine-learning computational model may be retrained, using the plurality of known concentrations of the analyte in the calibration samples and the associated plurality of arrays of spectrometer output intensities, to output a concentration of the analyte in a target sample based on an input array of spectrometer output intensities of the target sample. Alternately, at 2404, a pre-processing method may be generated for use with the previously trained machine-learning computational model (e.g., to perform normalization, as discussed above).

For example, the training logic 1004 of a spectrometer support module 1000 may perform the operations of 2404.

At 2406, the retrained machine-learning computational model may be used as a calibration model for the analyte for subsequent spectrometer operation. Alternately, at 2406, the pre-processing method generated at 2404 may be performed along with the previously trained machine-learning computational model as a calibration model for the analyte for subsequent spectrometer operation. For example, the analyte concentration logic 1006 of a spectrometer support module 1000 may perform the operations of 2406.

The spectrometer support methods disclosed herein may include interactions with a human user (e.g., via the user local computing device 5020 discussed herein with reference to FIG. 20). These interactions may include providing information to the user (e.g., information regarding the operation of a spectrometer such as the spectrometer 5010 of FIG. 20, information regarding a sample being analyzed or other test or measurement performed by a spectrometer, information retrieved from a local or remote database, or other information) or providing an option for a user to input commands (e.g., to control the operation of a spectrometer such as the spectrometer 5010 of FIG. 20, or to control the analysis of data generated by a spectrometer), queries (e.g., to a local or remote database), or other information. In some embodiments, these interactions may be performed through a GUI that includes a visual display on a display device (e.g., the display device 4010 discussed herein with reference to FIG. 19) that provides outputs to the user and/or prompts the user to provide inputs (e.g., via one or more input devices, such as a keyboard, mouse, trackpad, or touchscreen, included in the other I/O devices 4012 discussed herein with reference to FIG. 19). The spectrometer support systems disclosed herein may include any suitable GUIs for interaction with a user. In some embodiments, the output logic 1008 may provide any of the GUIs disclosed herein.

FIG. 18 depicts an example GUI 3000 that may be used in the performance of some or all of the support methods disclosed herein, in accordance with various embodiments. As noted above, the GUI 3000 may be provided on a display device (e.g., the display device 4010 discussed herein with reference to FIG. 19) of a computing device (e.g., the computing device 4000 discussed herein with reference to FIG. 19) of a spectrometer support system (e.g., the spectrometer support system 5000 discussed herein with reference to FIG. 20), and a user may interact with the GUI 3000 using any suitable input device (e.g., any of the input devices included in the other I/O devices 4012 discussed herein with reference to FIG. 19) and input technique (e.g., movement of a cursor, motion capture, facial recognition, gesture detection, voice recognition, actuation of buttons, etc.).

The GUI 3000 may include a data display region 3002, a data analysis region 3004, a spectrometer control region 3006, and a settings region 3008. The particular number and arrangement of regions depicted in FIG. 18 is simply illustrative, and any number and arrangement of regions, including any desired features, may be included in a GUI 3000.

The data display region 3002 may display data generated by a spectrometer (e.g., the spectrometer 5010 discussed herein with reference to FIG. 20). For example, the data display region 3002 may display an output intensity signal from a spectrometer (which may be background-corrected or otherwise processed by the spectrometer intensity logic 1002).

The data analysis region 3004 may display the results of data analysis (e.g., the results of analyzing the data illustrated in the data display region 3002 and/or other data). For example, the data analysis region 3004 may display the concentration of an analyte of interest in a sample (e.g., as determined by the analyte concentration logic 1006 in accordance with any of the embodiments disclosed herein), one or more feature relevance indicators (e.g., as determined by the analyte concentration logic 1006 in accordance with any of the embodiments disclosed herein), or any other suitable information. In some embodiments, the data display region 3002 and the data analysis region 3004 may be combined in the GUI 3000 (e.g., to include data output from a spectrometer, and some analysis of the data, in a common graph or region).

The spectrometer control region 3006 may include options that allow the user to control a spectrometer (e.g., the spectrometer 5010 discussed herein with reference to FIG. 20). For example, the spectrometer control region 3006 may include options to begin or otherwise control analysis of a sample by a spectrometer.

The settings region 3008 may include options that allow the user to control the features and functions of the GUI 3000 (and/or other GUIs) and/or perform common computing operations with respect to the data display region 3002 and data analysis region 3004 (e.g., saving data, such as analyte concentration and/or feature relevance indicators, on a storage device, such as the storage device 4004 discussed herein with reference to FIG. 19, sending data, such as analyte concentration and/or feature relevance indicators, to another user, labeling data, etc.).

As noted above, the spectrometer support module 1000 may be implemented by one or more computing devices. FIG. 19 is a block diagram of a computing device 4000 that may perform some or all of the spectrometer support methods disclosed herein, in accordance with various embodiments. In some embodiments, the spectrometer support module 1000 may be implemented by a single computing device 4000 or by multiple computing devices 4000. Further, as discussed below, a computing device 4000 (or multiple computing devices 4000) that implements the spectrometer support module 1000 may be part of one or more of the spectrometer 5010, the user local computing device 5020, the service local computing device 5030, or the remote computing device 5040 of FIG. 20. In some embodiments, the processor 14, the memory 15, and the I/O unit 16 may be part of the computing device 4000.

The computing device 4000 of FIG. 19 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 19, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry (e.g., a connector and driver circuitry) to which a display device 4010 may be coupled.

The computing device 4000 may include a processing device 4002 (e.g., one or more processing devices). As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 may include a storage device 4004 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random-access memory (eDRAM) or spin transfer torque magnetic random-access memory (STT-MRAM), for example. In some embodiments, the storage device 4004 may include non-transitory computer readable media having instructions thereon that, when executed by one or more processing devices (e.g., the processing device 4002), cause the computing device 4000 to perform any appropriate ones of or portions of the methods disclosed herein.

The computing device 4000 may include an interface device 4006 (e.g., one or more interface devices 4006). The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or BIuetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices (e.g., batteries or capacitors) and/or circuitry for coupling components of the computing device 4000 to an energy source separate from the computing device 4000 (e.g., AC line power).

The computing device 4000 may include a display device 4010 (e.g., multiple display devices). The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra-mobile personal computer, etc.), a desktop computing device, or a server computing device or other networked computing component.

One or more computing devices implementing any of the spectrometer support modules or methods disclosed herein may be part of a spectrometer support system. FIG. 20 is a block diagram of an example spectrometer support system 5000 in which some or all of the spectrometer support methods disclosed herein may be performed, in accordance with various embodiments. The spectrometer support modules and methods disclosed herein (e.g., the spectrometer support module 1000 of FIG. 3 and the methods of FIGS. 13-17) may be implemented by one or more of the spectrometer 5010, the user local computing device 5020, the service local computing device 5030, or the remote computing device 5040 of the spectrometer support system 5000. In some embodiments, the spectrometry system 10 of FIG. 1 may be part of a spectrometer support system 5000.

Any of the spectrometer 5010, the user local computing device 5020, the service local computing device 5030, or the remote computing device 5040 may include any of the embodiments of the computing device 4000 discussed herein with reference to FIG. 19, and any of the spectrometer 5010, the user local computing device 5020, the service local computing device 5030, or the remote computing device 5040 may take the form of any appropriate ones of the embodiments of the computing device 4000 discussed herein with reference to FIG. 19.

The spectrometer 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 6, and the processing devices 5002 included in different ones of the spectrometer 5010, the user local computing device 5020, the service local computing device 5030, or the remote computing device 5040 may take the same form or different forms. The storage device 5004 may take any suitable form, including the form of any of the storage devices 5004 discussed herein with reference to FIG. 6, and the storage devices 5004 included in different ones of the spectrometer 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 6, and the interface devices 5006 included in different ones of the spectrometer 5010, the user local computing device 5020, the service local computing device 5030, or the remote computing device 5040 may take the same form or different forms.

The spectrometer 5010, the user local computing device 5020, the service local computing device 5030, and the remote computing device 5040 may be in communication with other elements of the spectrometer support system 5000 via communication pathways 5008. The communication pathways 5008 may communicatively couple the interface devices 5006 of different ones of the elements of the spectrometer support system 5000, as shown, and may be wired or wireless communication pathways (e.g., in accordance with any of the communication techniques discussed herein with reference to the interface devices 4006 of the computing device 4000 of FIG. 19). The particular spectrometer support system 5000 depicted in FIG. 20 includes communication pathways between each pair of the spectrometer 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the spectrometer 5010, but may instead communicate with the spectrometer 5010 via the communication pathway 5008 between the service local computing device 5030 and the user local computing device 5020 and the communication pathway 5008 between the user local computing device 5020 and the spectrometer 5010.

The spectrometer 5010 may include any appropriate spectrometer, such as an inductively coupled plasma optical emission spectrometer (ICP-OES), a mass spectrometer, or any other suitable spectrometer.

The user local computing device 5020 may be a computing device (e.g., in accordance with any of the embodiments of the computing device 4000 discussed herein) that is local to a user of the spectrometer 5010. In some embodiments, the user local computing device 5020 may also be local to the spectrometer 5010, but this need not be the case; for example, a user local computing device 5020 that is in a user's home or office may be remote from, but in communication with, the spectrometer 5010 so that the user may use the user local computing device 5020 to control and/or access data from the spectrometer 5010. In some embodiments, the user local computing device 5020 may be a laptop, smartphone, or tablet device. In some embodiments the user local computing device 5020 may be a portable computing device.

The service local computing device 5030 may be a computing device (e.g., in accordance with any of the embodiments of the computing device 4000 discussed herein) that is local to an entity that services the spectrometer 5010. For example, the service local computing device 5030 may be local to a manufacturer of the spectrometer 5010 or to a third-party service company. In some embodiments, the service local computing device 5030 may communicate with the spectrometer 5010, the user local computing device 5020, and/or the remote computing device 5040 (e.g., via a direct communication pathway 5008 or via multiple “indirect” communication pathways 5008, as discussed above) to receive data regarding the operation of the spectrometer 5010, the user local computing device 5020, and/or the remote computing device 5040 (e.g., the results of self-tests of the spectrometer 5010, calibration coefficients used by the spectrometer 5010, the measurements of sensors associated with the spectrometer 5010, etc.). In some embodiments, the service local computing device 5030 may communicate with the spectrometer 5010, the user local computing device 5020, and/or the remote computing device 5040 (e.g., via a direct communication pathway 5008 or via multiple “indirect” communication pathways 5008, as discussed above) to transmit data to the spectrometer 5010, the user local computing device 5020, and/or the remote computing device 5040 (e.g., to update programmed instructions, such as firmware, in the spectrometer 5010, to initiate the performance of test or calibration sequences in the spectrometer 5010, to update programmed instructions, such as software, in the user local computing device 5020 or the remote computing device 5040, etc.). A user of the spectrometer 5010 may utilize the spectrometer 5010 or the user local computing device 5020 to communicate with the service local computing device 5030 to report a problem with the spectrometer 5010 or the user local computing device 5020, to request a visit from a technician to improve the operation of the spectrometer 5010, to order consumables or replacement parts associated with the spectrometer 5010, or for other purposes.

The remote computing device 5040 may be a computing device (e.g., in accordance with any of the embodiments of the computing device 4000 discussed herein) that is remote from the spectrometer 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the spectrometer 5010, perform analyses of the data generated by the spectrometer 5010 (e.g., in accordance with programmed instructions), facilitate communication between the user local computing device 5020 and the spectrometer 5010, and/or facilitate communication between the service local computing device 5030 and the spectrometer 5010.

In some embodiments, one or more of the elements of the spectrometer support system 5000 illustrated in FIG. 20 may not be present. Further, in some embodiments, multiple ones of various ones of the elements of the spectrometer support system 5000 of FIG. 20 may be present. For example, a spectrometer support system 5000 may include multiple user local computing devices 5020 (e.g., different user local computing devices 5020 associated with different users or in different locations). In another example, a spectrometer support system 5000 may include multiple spectrometers 5010, all in communication with service local computing device 5030 and/or a remote computing device 5040; in such an embodiment, the service local computing device 5030 may monitor these multiple spectrometers 5010, and the service local computing device 5030 may cause updates or other information may be “broadcast” to multiple spectrometers 5010 at the same time. Different ones of the spectrometers 5010 in a spectrometer support system 5000 may be located close to one another (e.g., in the same room) or farther from one another (e.g., on different floors of a building, in different buildings, in different cities, etc.). In some embodiments, a spectrometer 5010 may be connected to an Internet-of-Things (IoT) stack that allows for command and control of the spectrometer 5010 through a web-based application, a virtual or augmented reality application, a mobile application, and/or a desktop application. Any of these applications may be accessed by a user operating the user local computing device 5020 in communication with the spectrometer 5010 by the intervening remote computing device 5040. In some embodiments, a spectrometer 5010 may be sold by the manufacturer along with one or more associated user local computing devices 5020 as part of a local spectrometer computing unit 5012.

In some embodiments, different ones of the spectrometers 5010 included in a spectrometer support system 5000 may be different types of spectrometers 5010; for example, one spectrometer 5010 may be a mass spectrometer, while another spectrometer 5010 may be an optical spectrometer. In some such embodiments, the remote computing device 5040 and/or the user local computing device 5020 may combine data from different types of spectrometers 5010 included in a spectrometer support system 5000.

The following paragraphs provide various examples of the embodiments disclosed herein.

Example A1 is a spectrometer support apparatus, including: first logic to generate, for each of a plurality of calibration samples of an analyte at different known concentrations, an array of spectrometer output intensities of the calibration sample, wherein different ones of the spectrometer output intensities in the array are associated with data representative of different deflection amounts; second logic to train a machine-learning computational model, using the plurality of known concentrations of the analyte in the calibration samples and the associated plurality of arrays of spectrometer output intensities, to output a concentration of the analyte in a target sample based on an input array of spectrometer output intensities of the target sample; and third logic to use the trained machine-learning computational model as a calibration model for the analyte for subsequent spectrometer operation.

Example A2 includes the subject matter of Example A1, and further specifies that the spectrometer is an optical spectrometer and the data representative of different deflection amounts is data representative of different wavelengths of radiation.

Example A3 includes the subject matter of Example A1, and further specifies that the spectrometer is a mass spectrometer and the data representative of different deflection amounts is data representative of different mass-to-charge ratios.

Example A4 includes the subject matter of any of Examples A1-3, and further specifies that the analyte is a single element.

Example A5 includes the subject matter of any of Examples A1-4, and further specifies that a tensor input to the machine-learning computational model includes the spectrometer output intensities at the different deflection amounts.

Example A6 includes the subject matter of any of Examples A1-5, and further specifies that a tensor input to the machine-learning computational model includes ratios of different ones of the spectrometer output intensities at different deflection amounts.

Example A7 includes the subject matter of any of Examples A1-6, and further specifies that the array of spectrometer output intensities of a calibration sample is an array of background-corrected output intensities.

Example A8 includes the subject matter of any of Examples A1-7, and further specifies that: the calibration samples are first calibration samples; the analyte is a first analyte; the machine-learning computational model is a first machine-learning computational model; the first logic is to generate, for each of a plurality of second calibration samples of a second analyte at different known concentrations, an array of spectrometer output intensities of the second calibration sample, wherein different ones of the spectrometer output intensities in the array are associated with data representative of different deflection amounts, and the second analyte is different from the first analyte; second logic to train a second machine-learning computational model, using the plurality of known concentrations of the second analyte in the second calibration samples and the associated plurality of arrays of spectrometer output intensities, to output a concentration of the second analyte in a target sample based on an input array of spectrometer output intensities of the target sample; and third logic to use the trained second machine-learning computational model as a calibration model for the second analyte for subsequent spectrometer operation.

Example A9 includes the subject matter of Example A1-8, and further specifies that, for each of the plurality of calibration samples of the analyte at different known concentrations, the array of spectrometer output intensities of the calibration sample includes more than two output intensities.

Example A10 includes the subject matter of any of Examples A1-9, and further specifies that, for one or more of the plurality of calibration samples of the analyte at different known concentrations, the array of spectrometer output intensities of the calibration sample includes at least one saturated spectrometer output intensity.

Example BI1 is a spectrometer support apparatus, including: first logic to generate an array of spectrometer output intensities of a sample, wherein different ones of the spectrometer output intensities in the array are associated with data representative of different deflection amounts; second logic to provide, to a trained machine-learning computational model, the received array of spectrometer output intensities, wherein the trained machine-learning computational model is to output a concentration of an analyte in the sample; and third logic to output the concentration of analyte in the sample.

Example BI2 includes the subject matter of Example BI1, and further specifies that the spectrometer is an optical spectrometer and the data representative of different deflection amounts is data representative of different wavelengths of radiation.

Example BI3 includes the subject matter of Example BI1, and further specifies that the spectrometer is a mass spectrometer and the data representative of different deflection amounts is data representative of different mass-to-charge ratios.

Example BI4 includes the subject matter of any of Examples BI1-3, and further specifies that the analyte is a single element.

Example BI5 includes the subject matter of any of Examples BI1-4, and further specifies that the array of spectrometer output intensities of the sample is an array of background-corrected output intensities.

Example BI6 includes the subject matter of any of Examples BI1-5, and further specifies that the array of spectrometer output intensities of the sample includes more than two output intensities.

Example BI7 includes the subject matter of any of Examples BI1-6, and further specifies that the array of spectrometer output intensities of the sample includes at least one saturated spectrometer output intensity.

Example BI8 includes the subject matter of any of Examples BI1-7, and further specifies that the third logic is to output, to the display device, a feature relevance indicator associated with one or more of the spectrometer output intensities.

Example BI9 includes the subject matter of Example BI8, and further specifies that the feature relevance indicator associated with a spectrometer output intensity indicates that the spectrometer output intensity was more important to determination of the concentration of analyte in the sample than others of the spectrometer output intensities.

Example BI10 includes the subject matter of any of Examples BI8-9, and further specifies that the feature relevance indicator associated with two spectrometer output intensities indicates that a combination of the two spectrometer output intensities was more important to determination of the concentration of analyte in the sample than other combinations of spectrometer output intensities.

Example BI11 includes the subject matter of Example BI10, and further specifies that the feature relevance indicator associated with the two spectrometer output intensities indicates that a ratio of the two spectrometer output intensities was more important to determination of the concentration of analyte in the sample than other ratios of spectrometer output intensities.

Example BI12 includes the subject matter of any of Examples BI8-11, and further specifies that the feature relevance indicator includes a list of the particular data representative of different deflection amounts associated with particular spectrometer output intensities.

Example BI13 includes the subject matter of Example BI12, and further specifies that the feature relevance indicator includes a list of wavelengths more important to determination of the concentration of analyte in the sample than other wavelengths.

Example BI14 includes the subject matter of Example BI12, and further specifies that the feature relevance indicator includes a list of mass-to-charge ratios more important to determination of the concentration of analyte in the sample than other mass-to-charge ratios.

Example BI15 includes the subject matter of any of Examples BI1-14, and further specifies that the third logic is to output the concentration of analyte in the sample to a display device.

Example BII1 is a spectrometer support apparatus, including: first logic to generate an array of spectrometer output intensities of a sample, wherein different ones of the spectrometer output intensities in the array are associated with data representative of different deflection amounts; second logic to generate a concentration of an analyte in the sample based on the received array of spectrometer output intensities; and third logic to output the concentration of analyte in the sample and a feature relevance indicator associated with one or more of the spectrometer output intensities.

Example BII2 includes the subject matter of Example BII1, and further specifies that the spectrometer is an optical spectrometer and the data representative of different deflection amounts is data representative of different wavelengths of radiation.

Example BII3 includes the subject matter of Example BII1, and further specifies that the spectrometer is a mass spectrometer and the data representative of different deflection amounts is data representative of different mass-to-charge ratios.

Example BII4 includes the subject matter of any of Examples BII1-3, and further specifies that the analyte is a single element.

Example BII5 includes the subject matter of any of Examples BII1-4, and further specifies that the array of spectrometer output intensities of the sample is an array of background-corrected output intensities.

Example BII6 includes the subject matter of any of Examples BII1-5, and further specifies that the array of spectrometer output intensities of the sample includes more than two output intensities.

Example BII7 includes the subject matter of any of Examples BII1-6, and further specifies that the array of spectrometer output intensities of the sample includes at least one saturated spectrometer output intensity.

Example BII8 includes the subject matter of any of Examples BII1-7, and further specifies that the feature relevance indicator associated with a spectrometer output intensity indicates that the spectrometer output intensity was more important to determination of the concentration of analyte in the sample than others of the spectrometer output intensities.

Example BII9 includes the subject matter of any of Examples BII1-8, and further specifies that the feature relevance indicator associated with two spectrometer output intensities indicates that a combination of the two spectrometer output intensities was more important to determination of the concentration of analyte in the sample than other combinations of spectrometer output intensities.

Example BII10 includes the subject matter of Example BII9, and further specifies that the feature relevance indicator associated with the two spectrometer output intensities indicates that a ratio of the two spectrometer output intensities was more important to determination of the concentration of analyte in the sample than other ratios of spectrometer output intensities.

Example BII11 includes the subject matter of any of Examples BII1-10, and further specifies that the feature relevance indicator includes a list of the particular data representative of different deflection amounts associated with particular spectrometer output intensities.

Example BII2 includes the subject matter of Example BII1, and further specifies that the feature relevance indicator includes a list of wavelengths more important to determination of the concentration of analyte in the sample than other wavelengths.

Example BII3 includes the subject matter of Example BII1, and further specifies that the feature relevance indicator includes a list of mass-to-charge ratios more important to determination of the concentration of analyte in the sample than other mass-to-charge ratios.

Example BII4 includes the subject matter of any of Examples BII1-13, and further specifies that the third logic is to output the concentration of analyte in the sample to a display device.

Example BIII1 is a spectrometer output apparatus, including: first logic to generate an array of spectrometer output intensities of a sample, wherein different ones of the spectrometer output intensities in the array are associated with data representative of different deflection amounts; second logic to generate a concentration of an analyte in the sample based on the received array of spectrometer output intensities without a user having to select one or more of the data representative of deflection amounts in advance of the generation of the concentration of the analyte; and third logic to output the concentration of analyte in the sample.

Example BIII2 includes the subject matter of Example BIII1, and further specifies that the spectrometer is an optical spectrometer and the data representative of different deflection amounts is data representative of different wavelengths of radiation.

Example BIII3 includes the subject matter of Example BIII1, and further specifies that the spectrometer is a mass spectrometer and the data representative of different deflection amounts is data representative of different mass-to-charge ratios.

Example BIII4 includes the subject matter of any of Examples BIII1-3, and further specifies that the analyte is a single element.

Example BIII5 includes the subject matter of any of Examples BIII1-4, and further specifies that the array of spectrometer output intensities of the sample is an array of background-corrected output intensities.

Example BIII6 includes the subject matter of any of Examples BIII1-5, and further specifies that the array of spectrometer output intensities of the sample includes more than two output intensities.

Example BIII7 includes the subject matter of any of Examples BIII1-6, and further specifies that the array of spectrometer output intensities of the sample includes at least one saturated spectrometer output intensity.

Example BIII8 includes the subject matter of any of Examples BIII1-7, and further specifies that the third logic is to output, to the display device, a feature relevance indicator associated with one or more of the spectrometer output intensities.

Example BIII9 includes the subject matter of Example BIII8, and further specifies that the feature relevance indicator associated with a spectrometer output intensity indicates that the spectrometer output intensity was more important to determination of the concentration of analyte in the sample than others of the spectrometer output intensities.

Example BIII10 includes the subject matter of any of Examples BIII8-9, and further specifies that the feature relevance indicator associated with two spectrometer output intensities indicates that a combination of the two spectrometer output intensities was more important to determination of the concentration of analyte in the sample than other combinations of spectrometer output intensities.

Example BIII11 includes the subject matter of Example BIII10, and further specifies that the feature relevance indicator associated with the two spectrometer output intensities indicates that a ratio of the two spectrometer output intensities was more important to determination of the concentration of analyte in the sample than other ratios of spectrometer output intensities.

Example BIII12 includes the subject matter of any of Examples BIII8-11, and further specifies that the feature relevance indicator includes a list of the particular data representative of different deflection amounts associated with particular spectrometer output intensities.

Example BIII13 includes the subject matter of Example BIII12, and further specifies that the feature relevance indicator includes a list of wavelengths more important to determination of the concentration of analyte in the sample than other wavelengths.

Example BIII14 includes the subject matter of Example BIII12, and further specifies that the feature relevance indicator includes a list of mass-to-charge ratios more important to determination of the concentration of analyte in the sample than other mass-to-charge ratios.

Example BIII15 includes the subject matter of any of Examples BIII1-14, and further specifies that the third logic is to output the concentration of analyte in the sample to a display device.

Example C1 is a spectrometer support apparatus, including: first logic to generate, for each of a plurality of calibration samples of an analyte at different known concentrations, an array of spectrometer output intensities of the calibration sample, wherein different ones of the spectrometer output intensities in the array are associated with data representative of different deflection amounts; second logic to retrain a previously trained machine-learning computational model or generate a pre-processing method for use with the previously trained machine-learning computational model, using the plurality of known concentrations of the analyte in the calibration samples and the associated plurality of arrays of spectrometer output intensities, to output a concentration of the analyte in a target sample based on an input array of spectrometer output intensities of the target sample; and third logic to use the retrained machine-learning computational model, or perform the pre-processing method along with the previously trained machine-learning computational model, as a calibration model for the analyte for subsequent spectrometer operation.

Example C2 includes the subject matter of Example C1, and further specifies that the spectrometer is an optical spectrometer and the data representative of different deflection amounts is data representative of different wavelengths of radiation.

Example C3 includes the subject matter of Example C1, and further specifies that the spectrometer is a mass spectrometer and the data representative of different deflection amounts is data representative of different mass-to-charge ratios.

Example C4 includes the subject matter of any of Examples C1-3, and further specifies that the analyte is a single element.

Example C5 includes the subject matter of any of Examples C1-4, and further specifies that a tensor input to the machine-learning computational model includes the spectrometer output intensities at the different deflection amounts.

Example C6 includes the subject matter of any of Examples C1-5, and further specifies that a tensor input to the machine-learning computational model includes ratios of different ones of the spectrometer output intensities at different deflection amounts.

Example C7 includes the subject matter of any of Examples C1-6, and further specifies that the array of spectrometer output intensities of a calibration sample is an array of background-corrected output intensities.

Example C8 includes the subject matter of any of Examples C1-7, and further specifies that the spectrometer is a first spectrometer, and the previously trained machine-learning computational model was trained using data generated by a second spectrometer different from the first spectrometer.

Example C9 includes the subject matter of Example C8, and further specifies that an amount of data from first spectrometer used to retrain the previously trained machine-learning computational model is less than an amount of data from the second spectrometer used to previously train the machine-learning computational model.

Example C10 includes the subject matter of any of Examples C1-9, and further specifies that, for each of the plurality of calibration samples of the analyte at different known concentrations, the array of spectrometer output intensities of the calibration sample includes more than two output intensities.

Example C11 includes the subject matter of any of Examples C1-10, and further specifies that, for one or more of the plurality of calibration samples of the analyte at different known concentrations, the array of spectrometer output intensities of the calibration sample includes at least one saturated spectrometer output intensity.

Example C12 includes the subject matter of any of Examples C1-11, and further specifies that the second logic is to retrain a subset of the parameters of the previously trained machine-learning computational model.

Example C13 includes the subject matter of any of Examples C1-12, and further specifies that the second logic is to retrain only a last layer of the previously trained machine-learning computational model.

Example D includes any of the spectrometer support modules disclosed herein.

Example E includes any of the spectrometer support methods disclosed herein.

Example F includes any of the GUIs disclosed herein.

Example G includes any of the spectrometer support computing devices and systems disclosed herein.

Example H includes a spectrometer system including any of the spectrometer support modules or apparatuses disclosed herein.

Example I includes a spectrometer system configured to perform any of the spectrometer support methods disclosed herein.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

1. A spectrometer support apparatus, comprising:
first logic to generate an array of spectrometer output intensities of a sample, wherein different ones of the spectrometer output intensities in the array are associated with data representative of different deflection amounts;
second logic to provide, to a trained machine-learning computational model, the received array of spectrometer output intensities and at least one ratio between a spectrometer output intensity associated with one deflection amount and a spectrometer output intensity associated with a different deflection amount, wherein the trained machine-learning computational model is to output a concentration of an analyte in the sample; and
third logic to output the concentration of analyte in the sample.

2. The spectrometer support apparatus of claim 1, wherein the spectrometer is an optical spectrometer and the data representative of different deflection amounts is data representative of different wavelengths of radiation.

3. The spectrometer support apparatus of claim 1, wherein the spectrometer is a mass spectrometer and the data representative of different deflection amounts is data representative of different mass-to-charge ratios.

4. The spectrometer support apparatus of claim 1, wherein the analyte is a single element.

5. The spectrometer support apparatus of claim 1, wherein the array of spectrometer output intensities of the sample includes more than two output intensities.

6. A method of determining analyte concentration from spectrometer output intensities, comprising:
generating an array of spectrometer output intensities of a sample, wherein different ones of the spectrometer output intensities in the array are associated with data representative of different deflection amounts;
providing, to a trained machine-learning computational model, data representative of at least some of the received array of spectrometer output intensities, wherein the trained machine-learning computational model is to output a concentration of an analyte in the sample, and the data provided to the trained machine-learning computational model includes at least one ratio between a spectrometer output intensity associated with one deflection amount and a spectrometer output intensity associated with a different deflection amount; and
outputting the concentration of analyte in the sample.

7. The method of claim 6, further comprising:
generating, based on the output of the trained machine-learning computational model, a feature relevance indicator associated with one or more of the spectrometer output intensities.

8. The method of claim 7, wherein the feature relevance indicator associated with a spectrometer output intensity indicates that the spectrometer output intensity was more important to determination of the concentration of analyte in the sample than others of the spectrometer output intensities.

9. The method of claim 7, wherein the feature relevance indicator associated with two spectrometer output intensities indicates that a combination of the two spectrometer output intensities was more important to determination of the concentration of analyte in the sample than other combinations of spectrometer output intensities.

10. The method of claim 9, wherein the feature relevance indicator associated with the two spectrometer output intensities indicates that a ratio of the two spectrometer output intensities was more important to determination of the concentration of analyte in the sample than other ratios of spectrometer output intensities.

11. The method of claim 7, wherein generating the feature relevance indicator includes performing linear regression feature relevance, logistic regression feature relevance, or decision tree feature relevance.

12. The method of claim 7, wherein the feature relevance indicator includes a list of wavelengths more important to determination of the concentration of analyte in the sample than other wavelengths.

13. The method of claim 7, wherein the feature relevance indicator includes a list of mass-to-charge ratios more important to determination of the concentration of analyte in the sample than other mass-to-charge ratios.

14. A spectrometer system, comprising:
a spectrometer support module, including:
first logic to generate an array of spectrometer output intensities of a sample, wherein different ones of the spectrometer output intensities in the array are associated with data representative of different deflection amounts;
second logic to provide, to a trained machine-learning computational model, at least a ratio of spectrometer output intensities associated with different deflection amounts, wherein the trained machine-learning computational model is to output a concentration of an analyte in the sample; and
third logic to output the concentration of analyte in the sample.

15. The spectrometer system of claim 14, wherein the third logic is to output the concentration of analyte in the sample to a display device.

16. The spectrometer system of claim 15, wherein the third logic is to output, to the display device, a feature relevance indicator associated with one or more of the spectrometer output intensities.

17. The spectrometer system of claim 16, wherein the feature relevance indicator associated with a spectrometer output intensity indicates that the spectrometer output intensity was more important to determination of the concentration of analyte in the sample than others of the spectrometer output intensities.

18. The spectrometer system of claim 14, wherein the spectrometer is a mass spectrometer and the data representative of different deflection amounts is data representative of different mass-to-charge ratios.

19. The spectrometer system of claim 14, wherein the spectrometer is an optical spectrometer and the data representative of different deflection amounts is data representative of different wavelengths of radiation.

20. The spectrometer system of claim 14, wherein the analyte is a single element.
